(19) United States
(12) Patent Application Publication
(10) Pub. No.: US 2019/0129865 A1
(43) Pub. Date: May 2, 2019

(54) ENCRYPTION AND DECRYPTION OF DATA PERSISTED BY NON-VOLATILE MEMORY

(71) Applicant: Kaminario Technologies Ltd., Yokne'am ILIT (IL)

(72) Inventor: Yaacov Fenster, Petach Tikvah (IL)

(73) Assignee: Kaminario Technologies Ltd., Yokne'am ILIT (IL)

(21) Appl. No.: 16/170,402

(22) Filed: Oct. 25, 2018

Related U.S. Application Data
(60) Provisional application No. 62/580,539, filed on Nov. 2, 2017.
(60) Provisional application No. 62/727,012, filed on Sep. 5, 2018.

(51) Int. Cl. G06F 12/14; G06F 1/30; G06F 1/26; G06F 21/79; G06F 11/14; G06F 9/4401

(52) U.S. Cl. CPC G06F 12/1408; G06F 1/30; G06F 1/263; G06F 2201/805; G06F 11/1417; G06F 9/4403; G06F 2212/1052; G06F 21/79

(57) ABSTRACT

The presently disclosed subject matter includes a computer system and method that enable to encrypt and persist data stored on a volatile memory during an event that may result in the data being unavailable or destroyed. According to the disclosed technique, once the computer system regains its ability to safely store data on the volatile memory, the encrypted data is copied from the non-volatile memory used for persisting the data “as is” i.e. without being decrypted. The decryption is performed by the system's processing circuitry external to the non-volatile memory.

### FIELD OF THE PRESENTLY DISCLOSED SUBJECT MATTER

The presently disclosed subject matter is related to the field of computer memory infrastructure.

### BACKGROUND

Non-Volatile Random Access Memory (NVRAM) is a memory that retains stored data after the power supply is turned off. Some NVRAM modules available today, such as the Non-Volatile Dual In-line Memory Module (NVDIMM), are capable of providing protection against loss of data stored on a volatile memory. NVDIMM comprises a backup power source such as a battery, and is configured, responsive to a power failure, to copy data stored on a system's volatile memory, to a non-volatile memory to thereby protect the data. When power is restored, NVDIMM can copy the data back from the non-volatile memory to its previous location in the volatile memory.

### GENERAL DESCRIPTION

The presently disclosed subject matter includes a computer system and method (also referred to below as “data retention process”) that enable to encrypt and persist data stored on a volatile memory during an event that may result in the data being unavailable or destroyed. Such events are referred to herein in general as “data endangering events” and include for example, any one of: power failure, intentional or accidental shutdown or reboot of a computer system, kernel crash, or any other event that may damage or destroy data stored on a volatile memory or otherwise impede accessibility to data stored on a volatile memory.

According to the disclosed technique, once the system regains the ability to safely store data in the volatile memory, decrypted data is copied from the non-volatile memory used for persisting the data “as is” i.e. without being decrypted. The decryption is performed by a processing circuitry external to the non-volatile memory (e.g. by the processing system or some other designated process running on the system's processing circuitry) after the data is retrieved to the volatile memory. According to some examples, retrieval of encrypted data to the volatile memory process is executed following a BIOS initialization process as part of a re-booting process.

Because decryption is done separately, only after the encrypted data has been resorted to the volatile memory, decryption keys are not required to be stored locally on the same computer device and can be obtained before decryption, for example, from a remote device (e.g. over a communication network) following full system reboot. This allows to retain protection of the encrypted data even if the non-volatile memory used for persisting the data, or even the entire device, fall into the wrong hands. The disclosed technique provides this type of data protection without the need to change the design or operation of the BIOS, thereby simplifying its implementation and reducing its price tag.

According to some examples a computer system is disclosed, configured to protect data during a data endangering event (e.g. power failure of the primary power source), the computer system comprising:

a processing circuitry comprising at least one processor and a non-volatile memory module (NVM-module); the NVM-module comprising: a controller, a volatile memory and a non-volatile memory;

in case of a data endangering event , the controller is configured and operable to:

disconnect an external memory bus connecting between the volatile memory and the processing circuitry external to the NVM-module; connect an internal memory bus between the volatile memory and the controller; retrieve data stored in the volatile memory; use at least one encryption key for encrypting the retrieved data to thereby obtain encrypted data and store the encrypted data in the non-volatile memory;

once the computer system regains its ability to safely store data on the volatile memory (e.g. upon reboot restoration of the primary power source, and reboot of the computer system, if a system shutdown occurred) the controller is configured to copy the encrypted data from the non-volatile memory to the volatile memory to thereby obtain recovered encrypted data; disconnect the internal memory bus between the controller and the volatile memory and reconnect an external memory bus connecting between the volatile memory and the processing circuitry external to the NVM-module; and

utilize at least one decryption key; read the recovered encrypted data from the volatile memory; and decrypt the recovered encrypted data using the at least one decryption key to thereby obtain restored decrypted data in the volatile memory.

In addition to the above features, the method according to this aspect of the presently disclosed subject matter can optionally comprise one or more of features (i) to (xiii) below, in any technically possible combination or permutation.

i. wherein the NVM-module further comprises or is otherwise operatively connected to a secondary power source; the controller is configured, responsive to the data endangering event that includes a power failure that prevents a primary power source of the computer system from providing power necessary for maintaining data stored in the volatile memory in the computer system, to temporarily receive power from the secondary power source to enable storing the encrypted data in the non-volatile memory.
ii. wherein copying of the encrypted data from the non-volatile memory to the volatile memory is initiated by the BIOS and occurs before the operating system is operative.
iii. wherein the decryption of the encrypted data is carried out by an operating system or a process running above the operating system.
iv. wherein the processing circuitry is further configured to use the decrypted data to resume execution of an operation which has been interrupted as a result of the data endangering event.
v. wherein the processing circuitry is further configured to use the decrypted data when implementing an in-memory data-base.
vi. wherein the computer system is a data-storage system comprising one or more control units being operatively connected to a plurality of storage units constituting a physical storage space; the control unit is a computerized device comprising the processing circuitry and the NVM-module and is configured to handle read and write requests received from a host device over a communication link;
vii. wherein a control unit of the one or more control units is configured, responsive to an I/O request, to operate the processing circuitry for storing data in the non-volatile memory.
viii. wherein the at least one encryption key is a public key and the at least one decryption key is a private key.
ix. wherein the decryption key is received from a source external to the processing circuitry.
x. wherein the NVM-module is an NVDIMM device.
xi. wherein the NVM-module further comprises a second volatile memory used for storing the at least one encryption key.
xii. wherein the data endangering event is a system reboot.
xiii. wherein the data endangering event includes for example, any one of: a system kernel crash; accidental or intentional shutdown of the system, e.g. by a user; loss of a primary power source; and software or some other entity initiating a data preservation process.

According to another aspect of the presently disclosed subject matter there is provided a computer implemented method of protecting data in a computer system in case of a data endangering event (e.g. power failure preventing the primary power source from providing power for maintaining data stored on a volatile memory in the computer system), the method comprising:

responsive to a data endangering event:

in case the data endangering event includes failure of the primary power source, using a secondary power source for powering an NVM-module comprised or otherwise operatively connected to computer system,

and operating the NVM-module for:

disconnecting an external memory bus between the volatile memory and the processing circuitry external to the NVM-module and connecting an internal memory bus between the volatile memory and a controller of the NVM-module; retrieving data stored in the volatile memory and encrypting the data using at least one encryption key to thereby obtain encrypted data and storing the encrypted data in a non-volatile memory of the NVM- module;

once the computer system regains its ability to safely store data on the volatile memory (e.g. upon restoration of the primary power source) copying the encrypted data from the non-volatile memory to the volatile memory to thereby obtain recovered encrypted data;

disconnecting the internal memory bus between the controller and the volatile memory and re-connecting the external memory bus between the volatile memory and the processing circuitry external to the NVM-module; and

once the processing circuitry external to the NVM-module is operative, utilizing the processing circuitry for:

obtaining at least one decryption key; reading the recovered encrypted data from the volatile memory; and decrypting the recovered encrypted data using the at least one decryption key to thereby obtain restored decrypted data in the volatile memory.

According to another aspect of the presently disclosed subject matter there is provided a data storage system comprising at least one control unit operatively connected to a shared physical storage space and to one or more host computer devices, wherein the at least one control unit is configured to execute a data retention process in the event of a data endangering event (e.g. power failure of a primary power source powering the control unit), the control unit comprising:

a processing circuitry comprising at least one processor and a non-volatile memory module (NVM-module); the NVM-module comprising: a controller, a volatile memory and a non-volatile memory;

responsive to a data endangering event (e.g. power failure preventing the primary power source from providing power for maintaining data stored on the volatile memory), the controller is configured to:

disconnect an external memory bus connecting between the volatile memory and the processing circuitry external to the NVM-module; connect an internal memory bus between the volatile memory and the controller; retrieve data stored in the volatile memory; use at least one encryption key for encrypting the retrieved data to thereby obtain encrypted data and store the encrypted data in the non-volatile memory;

once the computer system regains its ability to safely store data on the volatile memory (e.g. upon restoration of the primary power source, and reboot of the computer system, if a system shutdown occurred), the controller is configured to copy the encrypted data from the non-volatile memory to the volatile memory to thereby obtain recovered encrypted data; disconnect the internal memory bus between the controller and the volatile memory and reconnect an external memory bus connecting between the volatile memory and the processing circuitry external to the NVM-module; and

once the processing circuitry is operative, the at least one processor is configured to:

receive at least one decryption key; read the recovered encrypted data from the volatile memory; and decrypt the recovered encrypted data using the at least one decryption key to thereby obtain restored decrypted data in the volatile memory.

According to another aspect of the presently disclosed subject matter there is provided a non-transitory computer readable storage medium tangibly embodying a program of instructions that, when executed by a computer, cause the computer to perform a method of protecting data in a computer system in case of a data endangering event, the computer system comprises a processing circuitry and a non-volatile memory module (NVM-module); the method comprising:

responsive to a data endangering event:

disconnecting a volatile memory in the NVM-module from a processing circuitry external to an NVM-module;

connecting the volatile memory in the NVM-module with a controller of the NVM-module;

retrieving data stored in the volatile memory and encrypting the data using at least one encryption key to thereby obtain encrypted data;

storing the encrypted data in a non-volatile memory in the NVM-module;

once the computer system regains its capability to safely store data on the volatile memory in the NVM-module, copying the encrypted data from the non-volatile memory in the NVM-module to the volatile memory in the NVM-module to thereby obtain recovered encrypted data;

disconnecting the controller from the volatile memory in the NVM-module;

re-connecting the volatile memory in the NVM-module and the processing circuitry external to the NVM-module; and

once the processing circuitry is operative, utilizing it for:

obtaining at least one decryption key;

reading the recovered encrypted data from the volatile memory in the NVM-module; and

decrypting the recovered encrypted data using the at least one decryption key to thereby obtain restored decrypted data in the volatile memory.

The computer implemented method, the data-storage system, the non-transitory computer readable storage medium disclosed herein according to various aspects, can optionally further comprise one or more of features (i) to (xiii) listed above, mutatis mutandis, in any technically possible combination or permutation.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic block-diagram illustration of a computer system according to examples of the presently disclosed subject matter;

FIG. 2 is a schematic block-diagram illustration of a computer data-storage system, according to examples of the presently disclosed subject matter;

FIG. 3 is a flowchart showing a sequence of operations performed responsive to occurrence of a data endangering event in a computer system, according to some examples of the presently disclosed subject matter; and

FIG. 4 is a flowchart showing a sequence of operations performed once the computer system regains its ability to safely store data in the volatile memory, according to some examples of the presently disclosed subject matter.

### DETAILED DESCRIPTION

It will be appreciated that for simplicity and clarity of illustration, elements shown in the figures have not necessarily been drawn to scale. For example, the dimensions of some of the elements may be exaggerated relative to other elements, for clarity. Further, where considered appropriate, reference numerals may be repeated among the figures to indicate corresponding or analogous elements.

Unless specifically stated otherwise, as apparent from the following discussions, it is appreciated that throughout the specification, discussions utilizing terms such as “receiving”, “disconnecting” ,“retrieving”, “reading”, “decrypting” or the like, include actions and/or processes of a computer that manipulate and/or transform data into other data, said data represented as physical quantities, e.g. such as electronic quantities, and/or said data representing the physical objects.

The terms “computer”, “computer system”, “computer device”, “control unit”, “server computer device” or the like as disclosed herein should be broadly construed to include any kind of electronic device with data processing circuitry, which includes a computer processing device configured to and operable to execute computer instructions stored, for example, on a computer memory being operatively connected thereto. Examples of such a device include: a digital signal processor (DSP), a microcontroller, a field programmable gate array (FPGA), an application specific integrated circuit (ASIC), or a device such as a laptop computer, a personal computer, a smartphone, etc.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

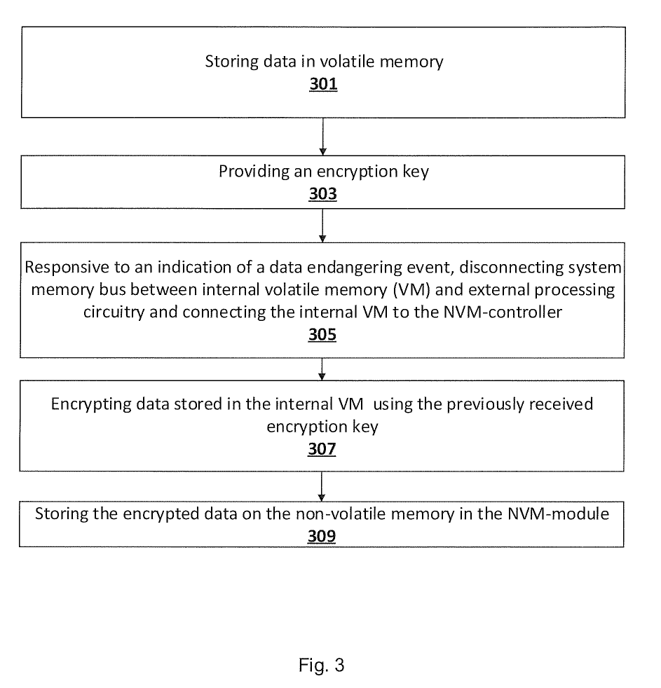

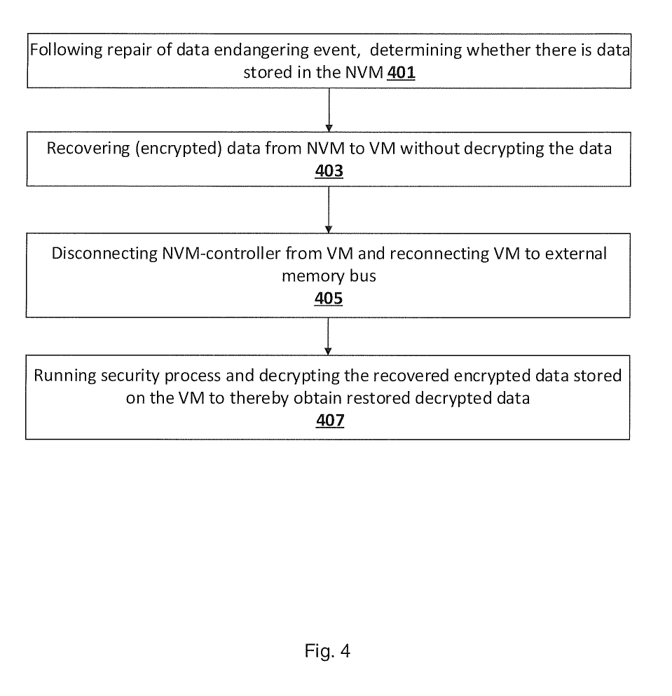

In embodiments of the presently disclosed subject matter, fewer, more and/or different stages than those shown in FIGS. 3 and 4 may be executed. In embodiments of the presently disclosed subject matter, one or more stages illustrated in FIGS. 3 and 4 may be executed in a different order and/or one or more groups of stages may be executed simultaneously. For example, in some implementations, operations described with reference to block 303 can be carried out before or together with operations described with reference to block 305.

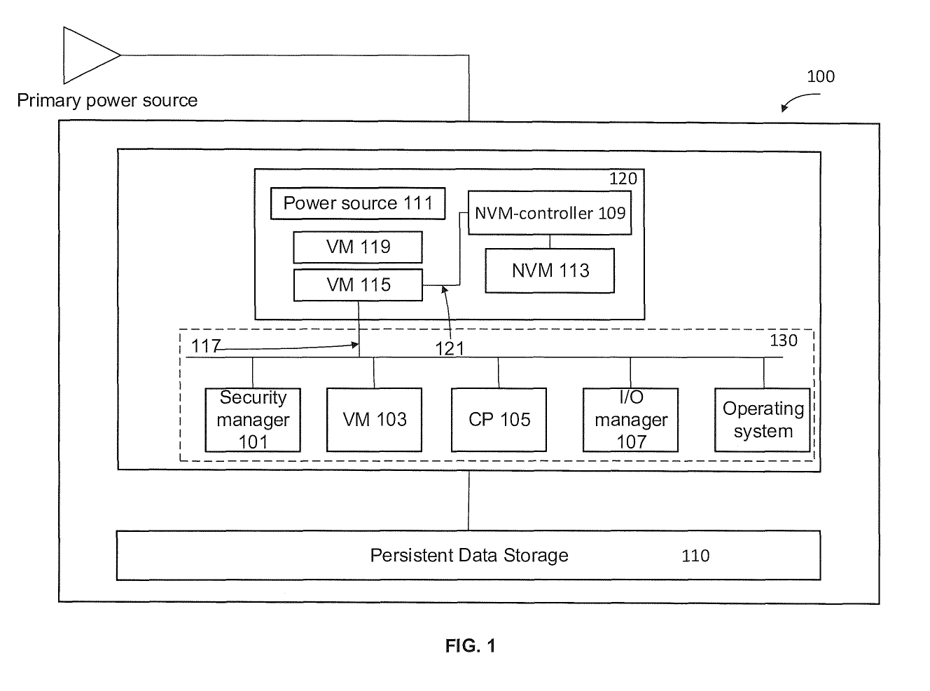

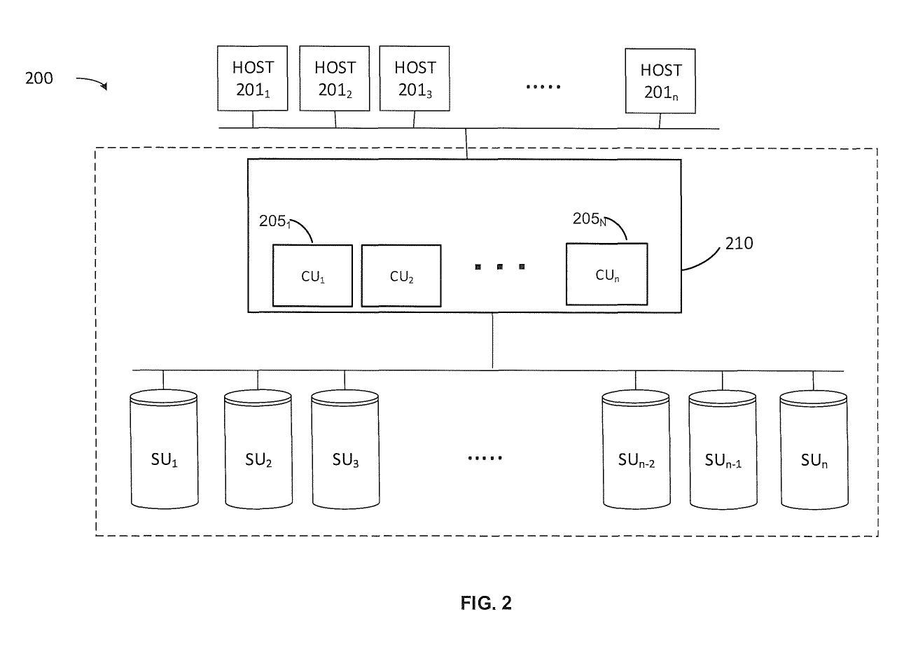

FIG. 1 to FIG. 2 illustrate various aspects of the system architecture in accordance with some examples of the presently disclosed subject matter. Elements in FIG. 1 to FIG. 2 can be made up of a combination of software and hardware and/or firmware that performs the functions as defined and explained herein. Elements in FIG. 1 to FIG. 2 may be centralized in one location or dispersed over more than one location. In other examples of the presently disclosed subject matter, the system may comprise fewer, more, and/or different elements than those shown in FIG. 1 to FIG. 2. For example, some components of control unit 205 described below with reference to FIG. 2 can be implemented as a separate unit in interface layer 210 or implemented on an external server computer device or be otherwise operatively connected to a control unit.

Bearing the above in mind, attention is drawn to FIG. 1, which is a schematic block-diagram of a computer system, according to some examples of the presently disclosed subject matter. Computer system 100 is powered by a primary power source e.g. a 220/110 voltage, electric power source, and comprises processing circuitry 130. Processing circuitry 130 is configured to provide the necessary processing capabilities to allow the computer system to function properly. Processing circuitry 130 comprises one or more computer processors (represented by computer processor 105 in FIG. 1) and can be configured to execute one or more functional modules e.g. in accordance with computer-readable instructions implemented on a non-transitory computer-readable memory comprised in the processing circuitry. Components in system 100 and specifically in processing circuitry 130 can be connected to one another by one or more buses, including for example one or more control buses, memory buses, address buses, data buses, system buses, etc.

Processing circuitry 130 comprises or is otherwise operatively connected to one or more volatile memory (VM) units 103 (also referred to herein as external VM, e.g. RAM) and to a persistent data storage 110. Persistent data storage can be any one of Hard Storage Devices (HDD) or Solid State Drives (SSD, comprising for example, a plurality of NAND elements), non-volatile RAM, or any other computer storage device or combination thereof.

Processing circuitry 130 further comprises or is otherwise operatively connected to one or more non-volatile memory modules (NVM-modules) 120. NVM-module 120 can be for example an NVIDIMM device. The NVM-module 120 comprises: NVM-controller 109 (implemented for example as an application specific integrated circuit-ASIC), non-volatile memory 113 (e.g. non-volatile RAM or NAND device), and volatile memory 115 (also referred to herein as “internal VM”). During normal system operation, volatile memory 115 can be connected to the system memory bus 117 (a bus used for I/O operations in VM 115) and operate as a normal VM, similar to VM 103. NVM-module 120 can further comprise or be otherwise operatively connected to a secondary (backup) power source 111 (e.g. battery or supercapacitor) for temporarily powering the NVM-module 120 (including at least VM 115, NVM 113 and NVM-controller 109) during data backup, in case the data endangering event is a failure of the primary power source to provide power to computer system 100).

Processing circuitry 130 can also comprise, by way of example, an I/O manager 107 configured to handle I/O requests received, for example, from another computer device (e.g. host computers 201₁₋ₙ as described below). According to some examples of the presently disclosed subject matter, processing circuitry 130 can further comprise security manager 101 configured, inter alia, to decrypt encrypted data recovered from NVM-module 120 once the system regains the ability to safely store data on the volatile memory (e.g. upon system reboot, in case a system shutdown occurred). The encrypted data includes data, previously stored on VM 115, that has been read, encrypted and written to the NVM 113 following a data endangering event and copied back to VM 115, as further explained below with reference to FIGS. 3 and 4.

In some examples, read and write operation (I/O operations) carried out at computer system 100 can be executed in response to a read or write request (input/output commands) received from a remote computer device. For example, computer system 100 can be implemented as server computer device being responsive to execute I/O requests received from host computers over a communication network (e.g. Internet or LAN network).

FIG. 2 is a schematic block-diagram illustration of a computer data-storage system (e.g. a highly available data-storage system), according to examples of the presently disclosed subject matter. Data-storage system 200 is one example of implementation of computer system 100 in a distributed computer system. Data-storage system 200 comprises one or more persistent storage devices SU₍₁₋ₙ₎ constituting a physical storage space of the storage system. As mentioned above, persistent storage devices may be any one of hard disk storage devices (HDD) or solid state drives (SSD, comprising for example, a plurality of NAND elements) or any other appropriate data storage device.

Data-storage system 200 can further comprise an interface layer 210 comprising various control units (CU 205₁₋ₙ) operatively connected to the physical storage space and to one or more hosts (201₁₋ₙ), and configured to control and execute various operations in the storage system. According to some examples of the presently disclosed subject matter, one or more control units 205₁₋ₙ comprise a processing circuitry similar or identical to processing circuitry 130 described above with reference to FIG. 1 and accordingly the control units are configured to have similar functionality to that of computer device 100. Control units 205₁₋ₙ are adapted to execute operations responsive to requests received from hosts 201₁₋ₙ. A host includes any computer device which communicates with interface layer 210 e.g. a PC computer, working station, a Smartphone, cloud host (where at least part of the processing is executed by remote computing services accessible via the cloud), or the like.

Notably, according to some examples, the presently disclosed subject matter contemplates a distributed storage system with an interface layer 210 configured with multiple interconnected control units 205₁₋ₙ (e.g. where the system is constructed over the cloud, the control units are located at different locations and communicate using for example, Non-Volatile Memory express (NVMe) or Non-Volatile Memory express over fabric (NVMe of)). As would be apparent to any person skilled in the art, unless stated otherwise, principles described herein with respect to a single control unit can be likewise applied to two or more control units in system 200. According to some examples, some components illustrated as part of processing circuitry 130 can be implemented as a unit separated from control unit 205 and operatively connected to the control unit or to more than one control unit and/or implemented on an external server computer device or otherwise operatively connected to the storage system.

Communication between hosts (201₁₋ₙ) and interface layer 210, between interface layer 210 and storage units (SU₁₋ₙ) and within interface layer 210 (e.g., between different control unit 205₁₋ₙ) can be realized by any suitable infrastructure and protocol. Hosts (201₁₋ₙ) can be connected to the interface layer 210 directly or through a network (e.g. over the Internet). According to one example, communication between various elements of storage system 200 is implemented with a combination of Fiber Channel (e.g. between hosts and interface layer 210), SCSI (e.g. between interface 210 and storage units) and InfiniBand (e.g. interconnecting different control units in interface 210) communication protocols. As mentioned above, according to another example, communication between various elements of storage system 200 is implemented using Non-Volatile Memory express (NVMe) or Non-Volatile Memory express over fabric (NVMe of) specifications.

According to some examples of the presently disclosed subject matter, control units 205₁₋ₙ can be adapted to read data (including metadata) from the storage (SU₁₋ₙ), and/or write data and/or metadata to the storage (SU₁₋ₙ). In response to receiving an I/O request, a control unit can be configured to determine with which address (LU,LBA) the I/O request is associated. The control unit can use address mapping tables (or mapping functions) to determine, based on the logical address referenced in the I/O request, to which storage location in the physical storage to address the I/O request.

In some examples, responsive to a write request received from a host device, before writing the data to persistent storage device 110, the data is temporarily stored in a volatile memory. As is well known in the art, this can occur for various reasons, such as: data concatenation into larger data chunks in order to reduce write overhead; execution of operations related to Redundant Array of Independent Disks (RAID) e.g. syndrome calculation and segment distribution; deduplication operations, and the like. Similarly, in response to a read request, data can be temporarily stored in a volatile memory before it is sent to a requesting entity (e.g. host). According to some examples, the volatile memory in which the data is temporarily stored is volatile memory 115 in NVM-module 120. Some operations performed by system 100 and system 200 with respect to the data stored in volatile memory 115 according to some examples of the presently disclosed subject matter are described below with reference to FIGS. 3 and 4.

FIG. 3 is a flowchart showing a sequence of operations performed during a data retention process, responsive to occurrence of a data endangering event, according to some examples of the presently disclosed subject matter. Operations described with reference to FIG. 3 and FIG. 4 can be executed for example, by computer system 100 or control unit 205 in data storage system 200. It should be appreciated however, that while some operations are described with reference to components of systems 100 and 200 this is done by way of example only, and other system designs providing the same or similar functionality can be likewise used.

As explained above, in various scenarios, data is stored in a volatile computer memory of a NVM-module e.g. DIMM of an NVDIMM device (block 301). According to some examples, an encryption key (possibly more than one) is provided to NVM-module 120 (block 303). The encryption key can be provided for example by another component of processing circuitry 130 such as an operating system or by an application running over the operating system or by a remote computer device over a communication network or some other connection. In some examples the encryption key is provided by security manager 101. The encryption key can be temporarily stored in a volatile memory other than VM 115 within NVM-module 120 (e.g. volatile memory 119 in NVM-module 120).

Data indicating of the occurrence of a data endangering event (referred to herein as a “endangered-data signal”) is received at NVM-module 120. For example, responsive to a system failure which includes a power failure such that the primary power source can no longer provide power for maintaining the data in the volatile memory, a power failure signal indicating imminent power loss is sent to NVM-module 120 (e.g. the endangered-data signal can be an asynchronous DRAM refresh signal (ADR) sent from the primary power source). The endangered-data signal can be sent directly from the power source or via one or more intermediaries. The endangered-data signal can also be sent by some other entity e.g. a software program running on the computer system. The endangered-data signal can be received by NVM-controller 109, which is configured, responsive to the received signal, to initiate the data retention process. If the endangered-data signal is indicative of an imminent loss of power of the primary power source (e.g. power failure signal) NVM-controller 109 is configured to switch to receiving power from the secondary power source 111 (block 305).

Controller 109 is further configured, responsive to the endangered-data signal, to disconnect the system memory bus 117 (a bus that enables execution of I/O operations in VM 115 the external processing circuitry) also referred to herein as “external memory bus”) connecting between VM 115 (internal VM) and processing circuitry external to NVM-module 120 (e.g. native processing circuitry of computer system 100 or control unit 205; referred to herein also as “external processing circuitry”) and connects (renders operative) memory bus 121 (a bus that enables execution of I/O operations in VM 115 by controller 109) also referred to herein as “internal memory bus”) between VM 115 and NVM-controller 109. In the example illustrated in FIG. 1 components of processing circuitry 130 which are located outside NVM-module 120 are part of the external processing circuitry.

Memory bus 117 is used for receiving data from the external processing circuitry and transmitting data to the external processing circuitry (e.g. during execution of I/O operations as mentioned above or in another example for implementing an in-memory data-base, which primarily relies on main memory for computer data storage and is directly accessible to the CPU).

Specifically, in case of an NVDIMM device, responsive to a data endangering event, a memory bus used for transmitting data between the DIMM component (volatile memory) and a system memory bus, is disconnected. According to common operational principles VM 115 cannot be simultaneously connected for data transmission via both the system memory bus 117 connecting VM 115 to the external processing circuitry 130 and memory bus 121 connecting VM 115 to the NVM-controller 109. Thus, according to this configuration, in order to allow reading of the data from DIMM (internal VM 115) by the NVM-controller 109 and transferring the data read to the NVM 113, the DIMM is disconnected from the system input source prior to connecting it to the NVM-controller 109.

Following disconnection of the system memory bus 117, data stored in VM 115 is encrypted using the previously obtained encryption key(s) (block 307) and the encrypted data is copied to NVM 113 (block 309). In the example of NVDIMM device, the data is persisted on the NVRAM. Copying of data from the volatile memory to the non-volatile memory continues until it is no longer possible. For example, in case the data endangering event is power loss of the main power source, the process of copying data from the volatile memory to the non-volatile memory continues until the secondary power source is depleted and the system shuts down completely. This process allows to persist data which is stored on computer system's volatile memory 115 (e.g. in the event of a power failure) and thereby avoids data loss.

Attention is now drawn to FIG. 4 that shows a flowchart of additional operations carried as part of the data retention process, according to some examples of the presently disclosed subject matter. At block 401 once the data endangering event is repaired and the VM can again safely store data (e.g., in the event of failure of the primary power source, following restoration of the primary power source, the system is powered up; or in the event of user initiated system shutdown, once the system is turned on again) it is determined (e.g. by NVM-controller 109) whether there is data (including for example encrypted data) stored on NVM 113. Encrypted data stored on NVM 113 is copied (e.g. by NVM-controller 109) to the VM 115 (block 403). The encrypted data is copied “as is” to the volatile memory 115 without being decrypted.

At block 405, NVM-controller 109 disconnects the memory bus connecting between the NVM-controller 109 and VM 115 (internal memory bus 121) and reconnects the VM 115 to the system's memory bus 117 (external memory bus), enabling data transfer between VM 115 and the external processing circuitry.

According to some examples, the above operations are initiated by the Basic Input/Output System (BIOS) and occur before the operating system (OS) is operative. This is so, since at this stage the operating system is not “up” (not operative) and, accordingly, copying data from NVM 113 to VM 115 and connecting the VM 115 to the system memory bus is possible without interrupting the operation of the operating system.

As system startup progresses and the system's processing circuitry, including the operating system, becomes operative, various processes are uploaded and executed by the system's processing circuitry (e.g. by computer processor 105). According to some examples, security manager 101 is executed as part of the operating system or as an application running above the operating system. Security manager 101 uses a decryption key for decrypting the recovered encrypted data “in place” on VM 115 (block 407). Thus, decryption of the encrypted data is performed by the system's processing circuitry which is external to the NVM-module 120 and not by the NVM-module. The decryption key (possibly more than one) can be received for example from an external source such as a remote computer device communicating with processing circuitry 130 (e.g. with security manager 101) over a communication network (e.g. secure communication network, cloud computing resource, host device, etc.), a system administrator or the like.

According to some examples, the encryption key(s) is a public key and the decryption key(s) is a private key. The private key is received from a source owning the private key (for example, a specific host device) for the purpose of gaining access to read the data.

An operation which may have been interrupted as a result of the data endangering event (e.g. power failure) can be resumed. For example, the decrypted data can be written in a storage unit SU in the physical storage space to complete a write command, or the decrypted data can be transmitted to a host device to complete a read command, and the like. In other examples the decrypted data can be written to the volatile memory, for example for the purpose of implementing in-memory data-base.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a computer-readable non-transitory memory tangibly embodying a program of instructions executable by the computer for performing the method of the presently disclosed subject matter. The term “non-transitory” is used herein to exclude transitory, propagating signals, but to otherwise include any volatile or non-volatile computer memory technology suitable to the application.

It is also to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

1. A computer system powered by a primary power source configured to protect data stored in a volatile memory in case of a data endangering event, the computer system comprising:
a processing circuitry comprising at least one processor and a non-volatile memory module (NVM-module); the NVM-module comprising: a controller, a volatile memory and a non-volatile memory;
in case of a data endangering event , the controller is configured and operable to:
disconnect an external memory bus connecting between the volatile memory and the processing circuitry external to the NVM-module; connect an internal memory bus between the volatile memory and the controller; retrieve data stored in the volatile memory; use at least one encryption key for encrypting the retrieved data to thereby obtain encrypted data and store the encrypted data in the non-volatile memory;
once the computer system regains its ability to safely store data on the volatile memory, the controller is configured to copy the encrypted data from the non-volatile memory to the volatile memory to thereby obtain recovered encrypted data; disconnect the internal memory bus between the controller and the volatile memory and reconnect the external memory bus connecting between the non-volatile memory and the processing circuitry external to the NVM-module; and
once the processing circuitry external of NVM-module is operative, the at least one processor is configured to:
utilize at least one decryption key; read the recovered encrypted data from the volatile memory; and decrypt the recovered encrypted data using the at least one decryption key to thereby obtain restored decrypted data in the volatile memory.

2. The computer system of claim 1, wherein copying of the encrypted data from the non-volatile memory to the volatile memory is initiated by the BIOS and occurs before the operating system is operative.

3. The computer system of claim 1, wherein the decryption of the encrypted data is carried out by an operating system or a process running above the operating system executed by the at least one processor.

4. The computer system of claim 1, wherein the processing circuitry is further configured to use the decrypted data to resume execution of an operation which has been interrupted as a result of a power failure.

5. The computer system of claim 1, wherein the processing circuitry is further configured to use the decrypted data when implementing an in-memory data-base.

6. The computer system of claim 1, wherein the computer system is a data-storage system comprising one or more control units being operatively connected to a plurality of storage units constituting a physical storage space; the control unit is a computerized device comprising the processing circuitry and the NVM-module and is configured to handle read and write requests received from a host device over a communication link;
wherein a control unit of the one or more control units is configured, responsive to an I/O request, to operate the processing circuitry for storing data in the non-volatile memory.

7. The computer system of claim 1, wherein the at least one encryption key is a public key and the at least one decryption key is a private key.

8. The computer system of claim 1, wherein the decryption key is received from a source external to the processing circuitry.

9. The computer system of claim 1, wherein the NVM-module is an NVDIMM device.

10. The computer system of claim 1, wherein the NVM-module further comprises a second volatile memory used for storing the at least one encryption key.

11. The computer system of claim 1, wherein the NVM-module further comprises or is otherwise operatively connected to a secondary power source; the controller is configured, in case the data endangering event includes a power failure that prevents a primary power source of the computer system from providing power necessary to maintain data stored in the volatile memory, to temporarily receive power from the secondary power source to enable to store the encrypted data in the non-volatile memory.

12. A computer implemented method of protecting data stored in a volatile memory in a computer system in case of a data endangering event, the method comprising:
responsive to a data endangering event:
operating the NVM-module for:
disconnecting an external memory bus between the volatile memory and the processing circuitry external to the NVM-module and connecting an internal memory bus between the volatile memory and a controller of the NVM-module;
retrieving data stored in the volatile memory and encrypting the data using at least one encryption key to thereby obtain encrypted data and storing the encrypted data in a non-volatile memory of the NVM-module;
once the computer system regains its capability to safely store data on the volatile memory, copying the encrypted data from the non-volatile memory to the volatile memory to thereby obtain recovered encrypted data;
disconnecting the internal memory bus between the controller and the volatile memory and re-connecting the external memory bus between the volatile memory and the processing circuitry external to the NVM-module; and
once the processing circuitry external to the NVM-module is operative, utilizing the processing circuitry for:
obtaining at least one decryption key;
reading the recovered encrypted data from the volatile memory; and
decrypting the recovered encrypted data using the at least one decryption key to thereby obtain restored decrypted data in the volatile memory.

13. The computer implemented method of claim 12, wherein copying of the encrypted data from the non-volatile memory to the volatile memory is initiated by the BIOS and occurs before the OS is operative.

14. The computer implemented method of claim 12, wherein the decryption of the encrypted data is carried out by an operating system or a process running above the operating system executed by the at least one processor.

15. The computer implemented method of claim 12 further comprising: using the decrypted data for resuming execution of an operation which has been interrupted as a result of the data endangering event.

16. The computer implemented method of claim 12 further comprising: using the decrypted data when implementing an in-memory data-base.

17. The computer implemented method of claim 12, wherein the computer system is a data-storage system comprising one or more control units being operatively connected to a plurality of storage units constituting a physical storage space; the control unit is a computerized device comprising the processing circuitry and the NVM-module and is configured to handle read and write requests received from a host device over a communication link;
the method further comprising, responsive to an I/O request, operating a control unit of the one or more control units for storing data in the non-volatile memory.

18. The computer implemented method of claim 12, wherein the at least one encryption key is a public key and the at least one decryption key is a private key.

19. The computer implemented method of claim 12 further comprising, storing the at least one encryption key in a second volatile memory within the NVM-mode.

20. The computer implemented method of claim 12 further comprising, in case the data endangering event includes a power failure that prevents a primary power source of the computer system from providing power necessary to maintain data stored in the volatile memory: temporarily receiving power from a secondary power source to enable the storing of the encrypted data in the non-volatile memory.

21. A data storage system comprising one or more control unit devices operatively connected to a shared physical storage space and to one or more host computer devices, where at least one control unit is configured to protect data stored in a volatile memory in case of a data endangering event occurring at the control unit, the control unit comprising:
a processing circuitry comprising at least one processor and a non-volatile memory module (NVM-module); the NVM-module comprising: a controller, a volatile memory and a non-volatile memory;
responsive to a data endangering event, the controller is configured to:
disconnect an external memory bus connecting between the volatile memory and the processing circuitry external to the NVM-module; connect an internal memory bus between the volatile memory and the controller; retrieve data stored in the volatile memory; use at least one encryption key for encrypting the retrieved data to thereby obtain encrypted data and store the encrypted data in the non-volatile memory;
once the computer system regains its capability to safely store data on the volatile memory, the controller is configured to copy the encrypted data from the non-volatile memory to the volatile memory to thereby obtain recovered encrypted data; disconnect the internal memory bus between the controller and the volatile memory and reconnect an external memory bus connecting between the volatile memory and the processing circuitry external to the NVM-module; and
once the processing circuitry is operative, the at least one processor is configured to:
receive at least one decryption key; read the recovered encrypted data from the volatile memory; and decrypt the recovered encrypted data using the at least one decryption key to thereby obtain restored decrypted data in the volatile memory.

22. The data storage system of claim 21, wherein the NVM-module further comprises or is otherwise operatively connected to a secondary power source; the controller is configured, in case the data endangering event includes a power failure that prevents a primary power source of the computer system from providing power necessary to maintain data stored in the volatile memory, to temporarily receive power from the secondary power source to enable to store the encrypted data in the non-volatile memory.

23. A non-transitory computer readable storage medium tangibly embodying a program of instructions that, when executed by a computer, cause the computer to perform a method of protecting data stored in a volatile memory in a computer system in case of a data endangering event, the computer system comprises a processing circuitry and a non-volatile memory module (NVM-module); the method comprising:
responsive to a data endangering event:
disconnecting a volatile memory in the NVM-module from a processing circuitry external to an NVM-module;
connecting the volatile memory in the NVM-module with a controller of the NVM-module;
retrieving data stored in the volatile memory in the NVM-module and encrypting the data using at least one encryption key to thereby obtain encrypted data;
storing the encrypted data in a non-volatile memory in the NVM-module;
once the computer system regains its capability to safely store data on the volatile memory in the NVM-module, copying the encrypted data from the non-volatile memory in the NVM-module to the volatile memory in the NVM-module to thereby obtain recovered encrypted data;
disconnecting the controller from the volatile memory in the NVM-module;
re-connecting the volatile memory in the NVM-module and the processing circuitry external to the NVM-module; and
once the processing circuitry is operative, utilizing it for:
obtaining at least one decryption key;
reading the recovered encrypted data from the volatile memory in the NVM-module; and
decrypting the recovered encrypted data using the at least one decryption key to thereby obtain restored decrypted data in the volatile memory.
